(19) United States
(12) Patent Application Publication
(10) Pub. No.: US 2013/0242303 A1
(43) Pub. Date: Sep. 19, 2013

(54) DUAL ANGLES OF INCIDENCE AND AZIMUTH ANGLES OPTICAL METROLOGY

(71) Applicant: Zhuan Liu, Fremont, CA (US)

(72) Inventor: Zhuan Liu, Fremont, CA (US)

(73) Assignee: Nanometrics Incorporated, Milpitas, CA (US)

(21) Appl. No.: 13/419,206

(22) Filed: Mar. 13, 2012

(51) Int. Cl. G01J 4/00; G01J 1/00; G01N 21/55

(52) U.S. Cl. 356/369; 356/445; 356/213

(57) ABSTRACT

A dual optical metrology system includes a first metrology device and a second metrology device, each producing light at different oblique angles of incidence on the same spot of a sample from different azimuth angles. The dual optical metrology system further includes a rotating stage or flip mirrors capable of altering the orientation of the light beams so the first and second metrology devices can measure the same spot on the sample at different orientations. Thus, the first and second metrology devices generate first and second sets of optical metrology data, respectively, at a first orientation with respect to the sample. After the sample is rotated, the first and second metrology devices generate third and fourth sets of optical metrology data. The first, second, third, and fourth sets of data can then be used to determine one or more parameters of the sample.

### FIELD OF THE INVENTION

The invention relates to an optical measurement instrument, and more particularly to a metrology tool with dual angles of incidence and azimuth angles.

### BACKGROUND

The semiconductor industry, as well as other complex nanotechnology process industries, requires very tight tolerances in process control. As dimensions of chip continue to shrink, the tolerance requirements continue to become tighter. Accordingly, new more precise ways of measuring very small dimensions, e.g., on the order of a few nanometers, is desired. At this scale, typical microscopies, such as optical microscopy, or Scanning Electron Microscopy, are not suitable to obtain the desired precision, or to make quick, non-invasive measurements, which are also desirable.

Optical metrology techniques have been presented as a solution. The basic principle of optical metrology techniques is to reflect and/or scatter light from a target, and measure the resulting light. The received signal can be based simply on the reflectance of the light from the sample, or the change in polarization state (Psi, Del) of the light caused by the sample. The light may be modeled to retrieve the geometries or other desired parameters of the illuminated sample. Continued improvements in optical metrology, however, are desirable.

### SUMMARY

A dual optical metrology system includes a first metrology device and a second metrology device, each producing light at different oblique angles of incidence on the same spot of a sample from different azimuth angles. The dual optical metrology system further includes a rotating stage that is capable of rotating the sample so the first and second metrology devices can measure the same spot on the sample at different orientations. Thus, the first and second metrology devices generate first and second sets of optical metrology data, respectively, at a first orientation with respect to the sample. After the sample is rotated, the first and second metrology devices generate third and fourth sets of optical metrology data. The first, second, third, and fourth sets of data can then be used to determine one or more parameters of the sample.

In one implementation, a method includes generating a first set of optical metrology data using a first light source that produces a first beam of light that is obliquely incident on a spot on a sample at a first angle of incidence with respect to the sample and at a first azimuth angle; generating a second set of optical metrology data using a second light source that produces a second beam of light that is obliquely incident on the spot at a second angle of incidence with respect to the sample and at a second azimuth angle, wherein the second angle of incidence is different than the first angle of incidence and the second azimuth angle is different than the first azimuth angle; altering the orientation of the first beam of light with respect to the sample and the second beam of light with respect to the sample; generating a third set of optical metrology data after altering the orientation by producing a third beam of light that is obliquely incident on the spot at the first angle of incidence with respect to the sample and at a third azimuth angle; generating a fourth set of optical metrology data after altering the orientation by producing a fourth beam of light that is obliquely incident on the spot at the second angle of incidence with respect to the sample and at a fourth azimuth angle, wherein the third azimuth angle is different than the fourth azimuth angle; and using the first set of optical metrology data, the second set of optical metrology data, the third set of optical metrology data, and the fourth set of optical metrology data together to determine at least one parameter of the sample.

In one implementation, an apparatus includes a first light source that produces a first beam of light that is obliquely incident on a spot on a sample at a first angle of incidence with respect to the sample; a first detector that detects the first beam of light after interacting with the sample; a second light source that produces a second beam of light that is obliquely incident on the spot at a second angle of incidence with respect to the sample, wherein the second angle of incidence is different than the first angle of incidence and wherein the first light source and the second light source are positioned at different angles with respect to the sample to produce the first beam of light and the second beam of light with different azimuth angles; a second detector that detects the second beam of light after interacting with the sample; means for altering the orientation of the first beam of light with respect to the sample and the second beam of light with respect to the sample; and a processor coupled to receive data from the first detector and data from the second detector and coupled to control the means for altering the orientation, the processor configured to control the means for altering the orientation to produce a first orientation of the first beam of light with respect to the sample while the first detector generates and provides to the processor a first data set based on the first beam of light interacting with the sample at a first azimuth angle and at the first angle of incidence, and to produce a second orientation of the second beam of light with respect to the sample while the second detector generates and provides to the processor a second data set based on the second beam of light interacting with the sample at a second azimuth angle and at the second angle of incidence, wherein the first azimuth angle and the second azimuth angle are different, the processor being further configured to control the means for altering the orientation to produce a third orientation of the first beam of light with respect to the sample so the first detector generates and provides to the processor a third data set based on the first beam of light interacting with the sample at a third azimuth angle and at a third angle of incidence, and to produce a fourth of the second beam of light with respect to the sample while the second detector generates and provides to the processor a fourth data set based on the second beam of light interacting with the sample at a fourth azimuth angle and at a fourth angle of incidence, wherein the third azimuth angle and the fourth azimuth angle are different, the processor being further configured to determine at least one parameter of the sample using the first data set, the second data set, the third data set, and the fourth data set together and to store the parameter of the sample.

In one implementation, a method includes producing a first beam of light having a first angle of incidence with respect to a sample, the first beam of light being obliquely incident on a target on the sample at a first azimuth angle with respect to the target; detecting the first beam of light after interacting with the target at the first azimuth angle to produce a first set of data; producing a second beam of light having a second angle of incidence with respect to the sample, the second beam of light being obliquely incident on the target at a second azimuth angle with respect to the target, wherein the second angle of incidence is different than the first angle of incidence and the second azimuth angle is different than the first azimuth angle; detecting the second beam of light after interacting with the target at the second azimuth angle to produce a second set of data; rotating a stage holding the sample; producing the first beam of light to be obliquely incident on the target at the first angle of incidence and at a third azimuth angle with respect to the target; detecting the first beam of light after interacting with the target at the third azimuth angle to produce a third set of data; producing the second beam of light to be obliquely incident on the target at the second angle of incidence and at a fourth azimuth angle with respect to the target, wherein the fourth azimuth angle is different than the third azimuth angle; detecting the second beam of light after interacting with the target at the fourth azimuth angle to produce a fourth set of data; and using the first set of data, the second set of data, the third set of data, and the fourth set of data together to determine a parameter of the sample.

### BRIEF DESCRIPTION OF THE DRAWINGS

FIG. 1A illustrates a dual beam metrology system that uses beams having different azimuth angles φ and different angles of incidence.

FIGS. 1B and 1C illustrate a dual beam metrology system that is similar to that shown in FIG. 1A but includes flip mirrors.

FIG. 2 is a flow chart of a method of using the dual beam metrology system to determine a characteristic of a sample.

FIG. 3, by way of example, illustrates an ellipsometer that may be used as the first metrology device and/or the second metrology device in the dual beam metrology system.

### DETAILED DESCRIPTION

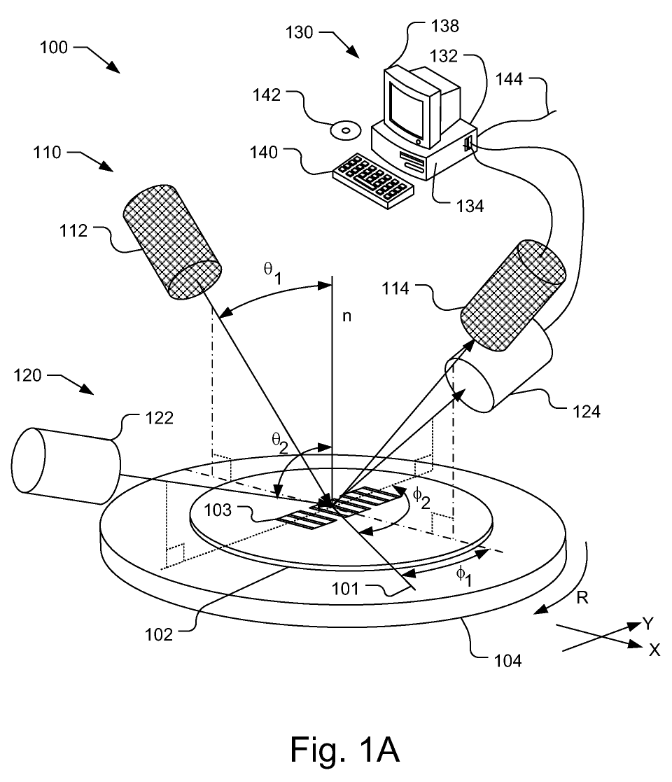

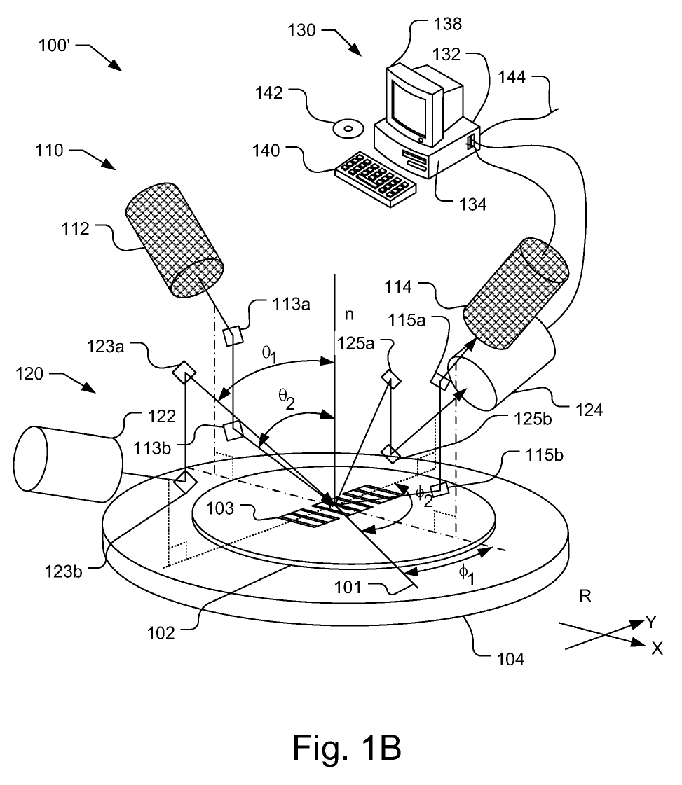

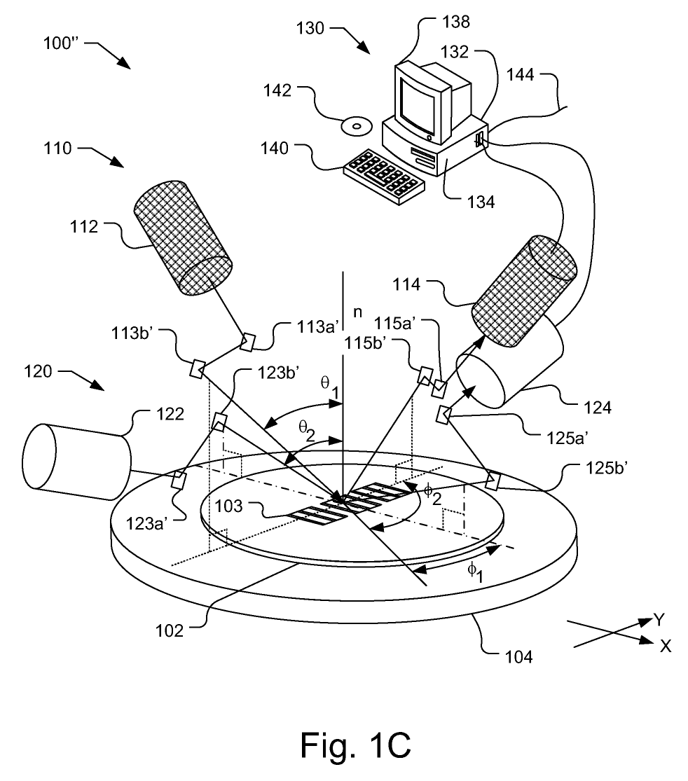

FIG. 1A illustrates a dual beam metrology system 100 that uses beams having different azimuth angles φ and different angles of incidence θ. The dual beam metrology system 100 is illustrated with a first metrology device 110 having a light source 112 and a detector 114 and which has an azimuth angle φ₁ shown with respect to an arbitrary reference line 101 on a sample 102 and an angle of incidence θ₁ with respect to surface normal n to the sample 102. The sample 102 may be, e.g., a semiconductor wafer or flat panel display or any other substrate. A second metrology device 120 is illustrated with a light source 122 and a detector 124 and with an azimuth angle φ₂ with respect to arbitrary reference line 101 and an angle of incidence θ₂ with respect to surface normal n. The azimuth angles φ₁ and φ₂ are different, and in one implementation may differ by 90°, but may differ by other amounts if desired. The angles of incidence θ₁ and θ₂ are also different and may vary between, e.g., 10° to 80°. The amount that the angles of incidence θ₁ and θ₂ differ may be, e.g., 10° to 70°.

In addition, the dual beam metrology system 100 further includes a rotating stage 104 that can rotate the sample 102, as illustrated by arrow R, as well as translate in the X and Y coordinates, as illustrated. The stage 104 may rotate the sample 102 between measurements of a target 103 so that data can be collected by the first metrology device 110 and second metrology device 120 from the target 103 at different azimuth angles. Thus, for example, where the azimuth angles φ₁ and φ₂ differ by 90°, the rotating stage 104 may rotate between a first measurement and a second measurement by the dual metrology system 100 so that measurements are produced at four different beam orientations, i.e., at (φ₁, θ₁) and (φ₂, θ₂) by the first metrology device 110 and the second metrology device 120, respectively, prior to rotating the stage, and at (φ₂, θ₁) and (φ₁, θ₂) by the first metrology device 110 and the second metrology device 120, respectively, after rotating the stage 104 by 90°. If desired, the azimuth angles between the first metrology device 110 and the second metrology device 120 may differ by an amount other than 90°. In such an implementation, the rotating stage 104 may rotate twice to produce the same four beam orientations, i.e., (φ₁, θ_{f}), (φ₂, θ_{f}), (φ₂, θ₂), and (φ₁, θ₂). If desired, other combinations of beam orientations may be produced by appropriate rotation of the stage 104 and/or selection of azimuth angles of the first metrology device 110 and the second metrology device 120. Moreover, if desired, the metrology system 100 may include additional metrology devices, which may use angles of incidence with oblique angles or normal incidence beams. If desired, the number of times that the stage rotates may be more than once, which produces more than four sets of data for analysis.

Thus, the dual beam metrology system 100 produces four optical metrology data sets: two data sets from the first metrology device 110, with beam orientations (φ₁, θ₁), (φ₂, θ₁) and two data sets from the second metrology device 120, with beam orientations (φ₂, θ₂), (φ₁, ∝₂). The detectors 114 and 124 are coupled to provide the four data sets to a computer 130, which includes a processor 132 with memory 134, as well as a user interface including e.g., a display 138 and input devices 140. A non-transitory computer-usable medium 142 having computer-readable program code embodied may be used by the computer 130 for causing the processor to control the device 100 and to perform the functions including the analysis described herein. The data structures and software code for automatically implementing one or more acts described in this detailed description can be implemented by one of ordinary skill in the art in light of the present disclosure and stored, e.g., on a computer readable storage medium 142, which may be any device or medium that can store code and/or data for use by a computer system such as processor 132. The computer-usable medium 142 may be, but is not limited to, magnetic and optical storage devices such as disk drives, magnetic tape, compact discs, and DVDs (digital versatile discs or digital video discs). A communication port 144 may also be used to receive instructions that are used to program the computer 130 to perform any one or more of the functions described herein and may represent any type of communication connection, such as to the internet or any other computer network. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

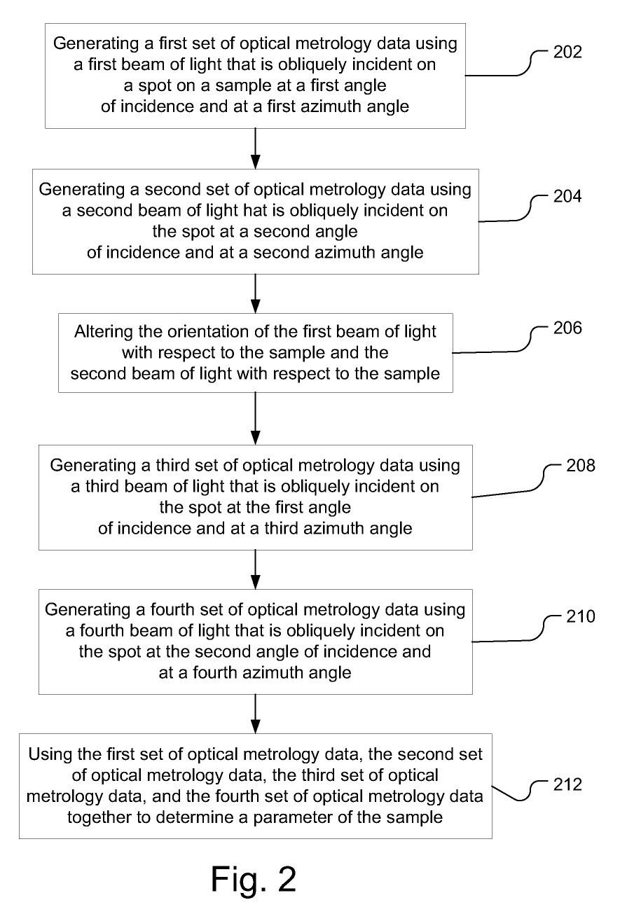

FIG. 2 is a flow chart of a method of using the dual beam metrology system to determine a characteristic of a sample. As illustrated in FIG. 2, a first set of optical metrology data is generated using a first beam of light that is obliquely incident on a spot on a sample at a first angle of incidence and at a first azimuth angle (202). Optical metrology data may be generated by producing a beam of light from a light source and detecting the beam of light after it interacts with the sample. A second set of optical metrology data is generated using a second beam of light that is obliquely incident on the same spot at a second angle of incidence and at a second azimuth angle (204). The second angle of incidence is different than the first angle of incidence and the second azimuth angle is different than the first azimuth angle. By way of example, the first set of optical metrology data may be produced by the first metrology device 110, shown in FIG. 1A, and the second set of optical metrology data may be produced by the second metrology device 120. The orientation of the first beam of light with respect to the sample and the second beam of light with respect to the sample is then altered (206). For example, a relative rotation may be produced between the sample and the first light source that produces the first beam of light and between the sample and the second light source that produces the second beam of light. As shown in FIG. 1A, the stage 104 may be rotated with respect to the light sources 112 and 122. Alternatively, if desired, the first metrology device 110 and the second metrology device 120 may be rotated with respect to the sample 102. Alternatively, rather than rotating the stage, flip mirrors may be used to alter the orientation, i.e., the angle of incidence and/or the azimuth angle, of the first beam of light and the second beam of light. FIG. 1B, by way of example, illustrates a metrology system 100′ that is the same as metrology system 100, shown in FIG. 1A, like designated elements being the same, except that metrology system 100′ includes flip mirrors 113a, 113b and 115a, 115b to alter the angle of incidence of the first light beam from light source 112 and includes flip mirrors 123a, 123b and 125a, 125b to alter the angle of incidence of the second light beam from light source 122 without rotating the stage 104. FIG. 1C illustrates a metrology system 100″ that is the same as metrology system 100, shown in FIG. 1A, like designated elements being the same, except that metrology system 100″ includes flip mirrors 113a′, 113b′ and 115a′, 115b′ to alter the azimuth angle of the first light beam from light source 112 and includes flip mirrors 123a′, 123b′ and 125a′, 125b′ to alter the angle of incidence of the second light beam from light source 122 without rotating the stage 104. Additionally, and/or alternatively, the azimuth angle of the first light beam from light source 112 and the azimuth angle of the second light beam from second source 122 may both be altered using flip mirrors.

A third set of optical metrology data is generated after altering the orientation (206) using a third beam of light that is obliquely incident on the same spot at the first angle of incidence and at a third azimuth angle (208). The third beam of light may be from the same light source as the first beam of light, e.g., as illustrated in FIGS. 1A and 1C or from the same light source as the second beam of light, e.g., as illustrated in FIG. 1B. A fourth set of optical metrology data is generated after producing the relative rotation using a fourth beam of light that is obliquely incident on the spot at the second angle of incidence and at fourth azimuth angle (210). The fourth beam of light may be from the same light source as the second beam of light, e.g., as illustrated in FIGS. 1A and 1C or from the same light source as the first beam of light, e.g., as illustrated in FIG. 1B. The third azimuth angle may be different than the fourth azimuth angle. By way of example, the third set of optical metrology data may be produced by the first metrology device 110, shown in FIG. 1A, and the third set of optical metrology data may be produced by the second metrology device 120. The first set of optical metrology data, the second set of optical metrology data, the third set of optical metrology data, and the fourth set of optical metrology data are used together to determine at least one parameter of the sample (212). For example, the optical metrology data may be compared to a reference database that includes a plurality of functions, where each of the functions corresponds to one or more parameters of the sample and the optical metrology data, which may be combined or compared to the reference database separately. Once the one or more parameters are obtained, the one or more parameters are stored, e.g., in memory 134 and maybe used in wafer process monitoring, closed-loop control or focus-exposure control in photolithography, or other desired processes.

The first metrology device 110 and second metrology device 120 of the dual beam metrology system 100 may employ any desired type of optical metrology, including ellipsometry, spectroscopic ellipsometry, Mueller Matrix ellipsometry, polarized reflectometry, or any other appropriate type of optical metrology. Moreover, the first metrology device 110 and second metrology device 120 may employ the same or different types of optical metrology. Further, the data collection from the first metrology device 110 and second metrology device 120 may be sequential or substantially simultaneous, e.g., within the capabilities of the processor 132.

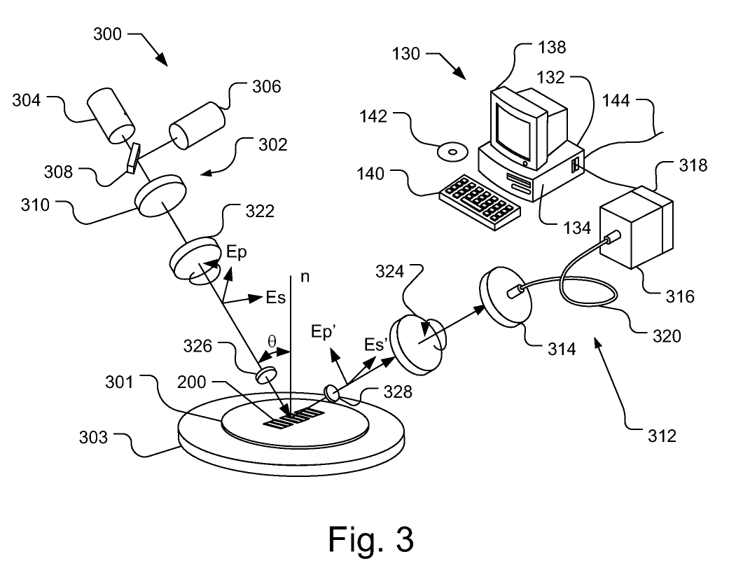

FIG. 3, by way of example, illustrates an ellipsometer 300 that may be used as the first metrology device 110 and/or the second metrology device 120. Ellipsometer 300 is illustrated as a rotating compensator ellipsometer that includes a light source in the form of a polarization state generator (PSG) 302 and detector in the form of a polarization state detector (PSD) 312. The PSG 302 produces light having a known polarization state and is illustrated as including light source 304 and 306, e.g., a Xenon Arc lamp and a Deuterium lamp, respectively, to produce light with a range of 200-3100 nm. A beam splitter 308 combine the light from the light sources 304, 306 and a polarizer 310 produces the known polarization state. It should be understood that additional, different, or fewer light sources may be used if desired.

The PSD 312 includes a polarizing element, referred to as an analyzer 314, a spectrometer 316 and a detector 318, which may be, e.g., a cooled CCD array, which is illustrated as coupled to the computer 130. The analyzer 314 is illustrated as being coupled to the spectrometer 316 and detector 318 via a fiber optic cable 320. It should be understood that other arrangements are possible, such as directly illuminating the spectrometer 316 from the analyzer 314 without the fiber optic cable 320.

The ellipsometer 300 is illustrated with two rotating compensators 322 and 324 between the PSG 302 and PSD 312. If desired, the ellipsometer 300 may use a single rotating compensator 322 or 324, e.g., between the PSG 302 and the sample 301 or between the sample 301 and the PSD 312, respectively. In another embodiment, the ellipsometer may use a rotating polarizer or analyzer configuration to generate the ellipsometric signals. In these cases, the compensator is not needed. The ellipsometer 300 may further include focusing elements 326 and 328 before and after the sample 301. The focusing elements may be, e.g., refractive or reflective lenses.

The ellipsometer 300 obliquely illuminates the sample 301, e.g., at a non-zero value of θ with respect to surface normal n. For example, the ellipsometer 300 may illuminate the sample 301 at an angle between 10° to 80°, for example at 65°, but other angles may be used if desired. By way of example, the ellipsometer may be a M2000 ellipsometer produced by JA Woollam Co., Inc.

As described above, other types of metrology devices may be used as one or both of the first metrology device 110 and second metrology devices 120. Moreover, additional metrology device may be used with the dual beam metrology system 100. For example, a normal incidence polarized reflectometer, or other similar instruments may be used with the dual beam metrology system 100 if desired.

The process of analyzing the metrology data obtained by the first metrology device 110 and the second metrology device 120 may vary depending, e.g., on the type of parameter or parameters being measured and the configuration of the sample. In one embodiment, for example, the sample may include a diffracting structure, where the optical metrology data is obtained by detecting the zeroth order diffraction from the diffracting structure. If desired, however, additional orders of the diffraction, e.g., the ±1st orders, may also be detected. The optical metrology data may be analyzed in the original data format or other converted or transformed formats, for example, linear combination, principal components, etc. The sample structure may include two dimensional lines or three dimensional structures. The parameters of the diffracting structure may include, e.g., a shape of lines, holes or islands, linewidth or line length, height, and wall angle of the diffracting structure and overlay shifts. Alternatively, the parameters may be, e.g., at least one of an optical index and film thickness of one or more films on the sample.

In one embodiment, the analysis of the optical metrology data may use real time regression, where the measurement data is compared to calculated data by real time calculations and parameters are determined by a nonlinear regression method, an optimization process to minimize the mean square error (MSE) between measurement data and the calculated data. The real time calculation may include Rigorous Couple Wave Analysis (RCWA), finite element, finite difference and machine learning methods. In another embodiment, the analysis of the optical metrology data may be done by a database or library method. The optical metrology data may be compared to a database or library that includes a plurality of functions, where each of the functions corresponds to the one or more parameters of the sample and the optical metrology data, which may be combined or compared to the reference database or library separately.

There may be different ways to determine the parameters in data analysis. In one case, all the parameters are determined in one step analysis, where all the metrology data are analyzed simultaneously. In another case, multiple steps of analysis may be used and for each step, partial parameters may be determined by partial data set. The data analysis may also include using different weights for different metrology data set to enhance the parameter sensitivity or reduce parameter correlation.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
generating a first set of optical metrology data using a first light source that produces a first beam of light that is obliquely incident on a spot on a sample at a first angle of incidence with respect to the sample and at a first azimuth angle;
generating a second set of optical metrology data using a second light source that produces a second beam of light that is obliquely incident on the spot at a second angle of incidence with respect to the sample and at a second azimuth angle, wherein the second angle of incidence is different than the first angle of incidence and the second azimuth angle is different than the first azimuth angle;
altering an orientation of the first beam of light with respect to the sample and an orientation of the second beam of light with respect to the sample;
generating a third set of optical metrology data after altering the orientation by producing a third beam of light that is obliquely incident on the spot at the first angle of incidence with respect to the sample and at a third azimuth angle;
generating a fourth set of optical metrology data after altering the orientation by producing a fourth beam of light that is obliquely incident on the spot at the second angle of incidence with respect to the sample and at a fourth azimuth angle, wherein the third azimuth angle is different than the fourth azimuth angle; and
using the first set of optical metrology data, the second set of optical metrology data, the third set of optical metrology data, and the fourth set of optical metrology data together to determine at least one parameter of the sample.

2. The method of claim 1, wherein altering the orientation of the first beam of light with respect to the sample and the second beam of light with respect to the sample comprises producing a relative rotation between the sample and the first light source and between the sample and the second light source, wherein the third beam of light is produced using the first light source and the fourth beam of light is produced using the second light source.

3. The method of claim 1, wherein altering the orientation of the first beam of light with respect to the sample and the second beam of light with respect to the sample comprises using flip mirrors to alter azimuth angles of the first beam of light and the second beam of light, wherein the third beam of light is produced using the first light source and the fourth beam of light is produced using the second light source.

4. The method of claim 1, wherein altering the orientation of the first beam of light with respect to the sample and the second beam of light with respect to the sample comprises using flip mirrors to alter angles of incidence of the first beam of light and the second beam of light, wherein the third beam of light is produced using the second light source and the fourth beam of light is produced using the first light source.

5. The method of claim 1, wherein the third azimuth angle and the second azimuth angle are the same.

6. The method of claim 1, wherein the first beam of light and the second beam of light are at oblique angles in a range of about 10 degrees to 80 degrees to a normal direction to the sample.

7. The method of claim 1, wherein the first beam of light and the second beam of light have angles of incidence that differ by between 10 degrees and 70 degrees.

8. The method of claim 1, wherein the sample comprises a diffracting structure at the spot on which the first beam of light and the second beam of light are obliquely incident.

9. The method of claim 8, wherein the generating the first set of optical metrology data comprises detecting a zeroth order diffraction of the first beam from the diffracting structure.

10. The method of claim 1, wherein at least one of the first beam of light and the second beam of light is polarized.

11. The method of claim 1, wherein the using the first set of optical metrology data, the second set of optical metrology data, the third set of optical metrology data, and the fourth set of optical metrology data together to determine the at least one parameter of the sample comprises using a reference database including a plurality of functions, each of which corresponding to one or more parameters of the sample and the first set of optical metrology data, the second set of optical metrology data, the third set of optical metrology data, and the fourth set of optical metrology data.

12. The method of claim 11, wherein each of the plurality of functions corresponds to the one or more parameters of the sample and a combination of the first set of optical metrology data, the second set of optical metrology data, the third set of optical metrology data, and the fourth set of optical metrology data.

13. The method of claim 1, wherein at least one of the first light source and the second light source produces light having multiple wavelengths.

14. The method of claim 1, wherein the at least one parameter of the sample comprises at least one of a shape of lines, linewidth, height and wall angle of a diffracting structure on the sample.

15. The method of claim 1, wherein the at least one parameter of the sample comprises at least one of an optical index and film thickness of at least one film on the sample.

16. The method of claim 1, wherein at least one of the first set of optical metrology data and the second set of optical metrology data comprises at least one of ellipsometry, spectroscopic ellipsometry, Mueller Matrix ellipsometry, and polarized reflectometry.

17. The method of claim 1, wherein the first set of optical metrology data and the second set of optical metrology data is generated substantially simultaneously.

18. The method of claim 1, further comprising using the at least one parameter of the sample in wafer process monitoring, closed-loop control or focus-exposure control in photolithography.

19. An apparatus comprising:
a first light source that produces a first beam of light that is obliquely incident on a spot on a sample at a first angle of incidence with respect to the sample;
a first detector that detects the first beam of light after interacting with the sample;
a second light source that produces a second beam of light that is obliquely incident on the spot at a second angle of incidence with respect to the sample, wherein the second angle of incidence is different than the first angle of incidence and wherein the first light source and the second light source are positioned at different angles with respect to the sample to produce the first beam of light and the second beam of light with different azimuth angles;
a second detector that detects the second beam of light after interacting with the sample;
means for altering an orientation of the first beam of light with respect to the sample and an orientation of the second beam of light with respect to the sample; and
a processor coupled to receive data from the first detector and data from the second detector and coupled to control the means for altering the orientation, the processor configured to control the means for altering the orientation to produce a first orientation of the first beam of light with respect to the sample while the first detector generates and provides to the processor a first data set based on the first beam of light interacting with the sample at a first azimuth angle and at the first angle of incidence, and to produce a second orientation of the second beam of light with respect to the sample while the second detector generates and provides to the processor a second data set based on the second beam of light interacting with the sample at a second azimuth angle and at the second angle of incidence, wherein the first azimuth angle and the second azimuth angle are different, the processor being further configured to control the means for altering the orientation to produce a third orientation of the first beam of light with respect to the sample so the first detector generates and provides to the processor a third data set based on the first beam of light interacting with the sample at a third azimuth angle and at a third angle of incidence, and to produce a fourth of the second beam of light with respect to the sample while the second detector generates and provides to the processor a fourth data set based on the second beam of light interacting with the sample at a fourth azimuth angle and at a fourth angle of incidence, wherein the third azimuth angle and the fourth azimuth angle are different, the processor being further configured to determine at least one parameter of the sample using the first data set, the second data set, the third data set, and the fourth data set together and to store the at least one parameter of the sample.

20. The apparatus of claim 19, wherein the means for altering the orientation comprises a rotating stage that holds the sample, and wherein the third angle of incidence is equal to the first angle of incidence and the fourth angle of incidence is equal to the second angle of incidence.

21. The apparatus of claim 19, wherein the means for altering the orientation comprises flip mirrors, and wherein the third angle of incidence is equal to the first angle of incidence and the fourth angle of incidence is equal to the second angle of incidence.

22. The apparatus of claim 19, wherein the means for altering the orientation comprises flip mirrors, and wherein the third azimuth angle is equal to the first azimuth angle and the fourth azimuth angle is equal to the second azimuth angle.

23. The apparatus of claim 19, wherein the third azimuth angle and the second azimuth angle are the same.

24. The apparatus of claim 19, wherein the first light source and the second light source are positioned to produce the first beam of light and the second beam of light, respectively, at an oblique angle in a range of about 10 to 80 degrees to a normal direction to the sample.

25. The apparatus of claim 19, wherein the first light source and the second light source are positioned to produce the first beam of light and the second beam of light, respectively, at angles of incidence that differ by between 10 degrees and 70 degrees.

26. The apparatus of claim 19, wherein the sample comprises a diffracting structure at the spot on which the first beam of light and the second beam of light are obliquely incident.

27. The apparatus of claim 26, wherein the first detector is configured to detect a zeroth order diffraction of the first beam of light from the diffracting structure.

28. The apparatus of claim 19, further comprising a first polarizer that polarizes the first beam of light and a second polarizer that polarizes the second beam of light.

29. The apparatus of claim 19, wherein the processor is configured to use the first data set, the second data set, the third data set, and the fourth data set together to determine the at least one parameter of the sample by being configured to use a reference database including a plurality of functions, each of which corresponding to one or more parameters of the sample and the first data set, the second data set, the third data set, and the fourth data set.

30. The apparatus of claim 29, wherein each of the plurality of functions corresponds to the one or more parameters of the sample and a combination of the first data set, the second data set, the third data set, and the fourth data set.

31. The apparatus of claim 19, wherein at least one of the first light source and the second light source produces light having multiple wavelengths.

32. The apparatus of claim 19, wherein the at least one parameter of the sample comprises at least one of a shape of lines, linewidth, height and wall angle of a diffracting structure on the sample.

33. The apparatus of claim 19, wherein the at least one parameter of the sample comprises at least one of an optical index and film thickness of at least one film on the sample.

34. The apparatus of claim 19, wherein at least one of the first detector and the second detector are part of at least one of ellipsometer, spectroscopic ellipsometer, Mueller Matrix ellipsometer, and polarized reflectometer.

35. The apparatus of claim 19, wherein the first data set and the second data set are generated substantially simultaneously.

36. A method comprising:
producing a first beam of light having a first angle of incidence with respect to a sample, the first beam of light being obliquely incident on a target on the sample at a first azimuth angle with respect to the target;
detecting the first beam of light after interacting with the target at the first azimuth angle to produce a first set of data;
producing a second beam of light having a second angle of incidence with respect to the sample, the second beam of light being obliquely incident on the target at a second azimuth angle with respect to the target, wherein the second angle of incidence is different than the first angle of incidence and the second azimuth angle is different than the first azimuth angle;
detecting the second beam of light after interacting with the target at the second azimuth angle to produce a second set of data;
rotating a stage holding the sample;
producing the first beam of light to be obliquely incident on the target at the first angle of incidence and at a third azimuth angle with respect to the target;
detecting the first beam of light after interacting with the target at the third azimuth angle to produce a third set of data;
producing the second beam of light to be obliquely incident on the target at the second angle of incidence and at a fourth azimuth angle with respect to the target, wherein the fourth azimuth angle is different than the third azimuth angle;
detecting the second beam of light after interacting with the target at the fourth azimuth angle to produce a fourth set of data; and
using the first set of data, the second set of data, the third set of data, and the fourth set of data together to determine a parameter of the sample.
